(19) United States
(12) Patent Application Publication
(10) Pub. No.: US 2005/0209978 A1
(43) Pub. Date: Sep. 22, 2005

(54) Method and arrangement for control of the use of a service provided by the postal system for tracking and monitoring of postal shipments

(75) Inventor: Gerrit Bleumer, Schildow (DE)

Correspondence Address: SCHIFF HARDIN, LLP;PATENT DEPARTMENT, 6600 SEARS TOWER, CHICAGO, IL, 60606-6473, US

(73) Assignee: Francotyp-Postalia AG & Co. KG

(21) Appl. No.: 11/057,357

(22) Filed: Feb. 14, 2005

(30) Foreign Application Priority Data
Mar. 19, 2004 (DE) 10 2004 014 428.1

(51) Int. Cl. G06F 17/00

(52) U.S. Cl. 705/404

(57) ABSTRACT

In a method and arrangement for controlling the use of a service provided by the postal system for tracking and monitoring of postal shipments a service task is initiated as a result of a user input and transported postal shipments are tracked and postal shipment transport tracking information is processed (PTI) in a service device, and signaling conditions are preset, data sets with the signaling conditions are generated and stored in connection with a franking of mail pieces and an associated postal shipment identification is applied to the mail piece at a first location, mailing and PTI provision take place at a third location automatic PTI recall occurs from a third location and storage of the PTI occurs at a second location, data processing of the PTI takes place at the second location and a transfer of data back to the user proceeds from the second location, and the user is notified by signaling the presence of the PTI dependent on the pre-set signaling conditions.

### BACKGROUND OF THE INVENTION

1. Field of the Invention

The present invention concerns a method for controlling the use of a service provided by the postal system for tracking and monitoring postal shipments as well as an arrangement to implement such a method. The present invention is suitable for all postal markets in which postal organizations provide information about the transport of letters, and packages. It is in particular suitable for the use of service devices, franking machines and mail processing machines or computers with mail processing function (PC frankers) or any other device suitable for the creation of an interface for an authorized party for initiation of a service task to track transported postal shipments and for processing the postal shipment transport tracking information for an easier query by the authorized party.

2. Description of the Prior Art

Since the introduction of electronic (digital) printing in franking machines, variable information for elements of a print image can be quickly and easily exchanged (East German Patent 233 101, U.S. Pat. No. 4,746,234).

The previously typical print image for frankings comprises, from right to left, a value or franking stamp followed by a date or city stamp. The print image designates the mailing in a first position to the upper right on the letter (German OS 199 13 066).

This position may be shifted to the left in an advantageous manner for large letter formats. Within an approximately 74 mm long and approximately 30 mm wide surface area, the Deutsche Post AG also allows the printing of an advertisement stereotype an the printing of a shipment type (for example package, letter, printed matter or airmail) in the upper right corner of an envelope that is required for frankings.

Mailing of a single mail piece via different corporations/services to which have been assigned different conveyance task portions is known. From the German Utility Model 2003 14 910, it is known that a section of the print image is provided for a prepayment zone to be printed at a first position and another section is provided for special postal information to be printed at a second position. The aforementioned section contains a one-dimensional barcode as an identifier for the respective mail piece.

It is also known to generate information during the mailing of the mail piece about its destination, which information can be queried by a party authorized for this purpose. European Application 1 176 560 discloses a postal system with means for tracking and monitoring of postal shipments, wherein a label with a barcode is attached to a mail piece that is then transported to the post office. There the label is scanned and the information from the barcode is stored in a databank for the purpose of shipment tracking and monitoring. After the delivery of the mail piece to the receiver, the label is removed and is placed together with others on a separate sheet of paper that is transported back to the post office and is scanned there. The information from the barcode is again stored in the databank.

Given shipment of packages and packets with private couriers such as DHL, UPS, FedEx, etc. which provide their customers with specific transport tracking about their postal shipments information via the Internet, each shipment contains a unique identification upon deposit (or pick-up) of a shipment at or by the courier service. During the dispatch path, the courier records specific points that a shipment passes in its infrastructure, and at the conclusion records the confirmation of the receiver as soon as the shipment has been received and accepted. Optionally, a graphic image of the signature of the receiver is also recorded.

Via the Internet, the courier service offers its customers a WWW-supported query procedure wherein the customer can enter the identification about the shipment to be tracked into a web form and thereupon should promptly receive the available shipment tracking information. Generally, it is possible only to inquire about an individual shipment. This pull-method is impractical when larger quantities of postal shipments are sent, as is typical in the operation of franking machines. It is difficult to expect a customer to manually track via an individual queries via the WWW (World Wide Web) only some of a number of the customer's machine-franked shipments. For larger data quantities, a correspondingly higher time and cost expenditure results.

A letter-processing device for a letter that contains a returnable article is known from European Application 282357 (corresponding to U.S. Pat. No. 4,796,196). The letter contains a scannable code that identifies a receiver. From the code, a receiver location and a location to which the article can be returned can be determined via a databank. After the scanning of the code at a location, for example the receiver location, a notification is initiated.

A system and method for producing digital postage stamp used as a part of a value-added service in a postal shipping system is known from European Application 1 063 618 (Corresponding to U.S. Pat. No. 6,532,452). The printed postal data contain value-added service data. The latter comprise address information in order to be able to effect an electronic confirmation per e-mail to the postal shipper or an authorized third party.

From U.S. Pat. No. 6,208,910, it is known to determine information about the location reached during the mailing of the mail piece using a GPS.

An arrangement and method to provide a communication for loading service data for a terminal device is known from European Application 1 146 484. A service center fashioned for the downloading by devices with a credit and other service data is equipped with a databank and at least with one internal service for delivering messages. A connection unit of the service center automatically establishes a connection to the terminal device, which is equipped to reproduce a message specific to the customer during or after the communication. The selection of a message conforms to the technical configuration of the terminal device in order to implement a reproduction. The technical format of the message conforms to whether the message is transferred to a PC franker, to a franking machine or to another mail processing machine. The outlay in the service center or for the service provider is high due to the necessity of a databank and servicing thereof. Important parameters of the clients are stored in the databank.

### SUMMARY OF THE INVENTION

An object of the present invention is to provide a service for tracking transported postal shipments and to provide a method for processing received postal shipment transport tracking information. With reduced time and cost expenditure, the responsibilities on the part of the customer should remain low.

A further object is to control (in a user-friendly manner) the initiation of the application of a postal shipping ID by a suitable machine in order to enable the service. A further object is to enable preparation of a number of items of postal shipment transport tracking information provided by the respective mail carrier so as to automate the confirmation as much as possible, so that the confirmation ensues in a customer-friendly manner. This object is achieved at the postal shipping location in the form of automatically collecting, evaluating and preparing postal shipment transport tracking information in a franking machine or a suitable device or at another predetermined location and, if necessary, displaying it to an authorized party.

The invention assumes that a postal customer receives via a service device or a suitable communication terminal device, the relevant postal shipment transport tracking information (PTI) for shipments that have been pre-paid by machine. The PTI is prepared in a suitable manner, such that the important information is quickly, clearly and promptly displayed. A push-model provided in accordance with the invention in the form of an application program is advantageous relative to the known pull model for postal customers. While customers of courier services are accustomed to querying transport data regarding individual shipments themselves, due to the application program (i.e. without separate user query) a postal customer can now receive the collected PTI evaluated, prepared and displayed by his franking machine or a suitable communication end device. A postal customer furthermore has the possibility to designate as high-priority specific shipments or shipment types whose PTI are then collected in the course of the transport and is currently informed about their disposition, for example via messages per display of his franking machine, per e-mail or per SMS by means of a mobile radio telephone.

The method for controlling of the use of a service provided by the postal system for tracking and monitoring of postal shipments includes the following steps:
A) control of the initiation of a service task as a result of a user input for tracking of transported postal shipments and for processing of postal shipment transport tracking information in the service device, whereby the initiation includes at least the setting of alert flags, signaling conditions associated with carrier information, and a provision of a postal shipment identification (SID) applicable by a machine,
B) generation and storage of data sets with signaling conditions in connection with a franking of mail pieces and an application of the associated postal shipment identification (SID) at a first location,
C) mailing and provision of a postal shipment transport tracking information (PTI) associated with the respective mail piece by a postal data center of the postal carrier at a third location removed from the first location of the franking, whereby the provision includes sampling the postal shipment identification (SID) applied to the mail pieces, a generation and storage of the postal shipment transport tracking information (PTI) associated with the mail piece,
D) automatic PTI recall from the postal data center based on information of a service server of the service device manufacturer and PTI storage in a databank of the service server at a second location removed from the first location,
E) Request of a data transfer in the framework of a second service for a service device of the customer, independent of the first service to deliver postal shipment transport tracking information from the service server of the service device manufacturer, whereby the service device of the customer identifies and transfers (via identification data) the postal shipment transport tracking information (PTI) from the service server of the service device manufacturer from the second location to the service device at the first location of the franker, in connection with the use of the second service, or transfer of the postal shipment transport tracking information (PTI) to a further service device at a further location,
F) data comparison in the service device at the first location of the franker or at the further location, as well as signaling of the presence of a message to the user, corresponding to the pre-set signaling conditions.

The inventive arrangement includes information processor, a user interface with a display unit and with first operation elements for control of the initiation of a service task to track transported postal shipments, and second operation elements for processing of postal shipment transport tracking information. Notification of the user by the service device, as a result of the receipt or non-receipt of a PTI within a stipulated time window corresponding to a pre-setting relating to the notification type, ensues after the receipt of a PTI sent back by the service server during the implementation of the postal shipping and information processing in the service device of the user.

The information processor are operationally connected with the user interface, with a communication interface, with a program storage for an application program, a first non-volatile storage for PTI and a second non-volatile storage for conditions which are based on the service. For postal shipment identification, an identifier applicable at the shipper location is used that contains no address information about the shipper and just as little information about the location or the time of the franking or the assignment of the mail piece. For example, a randomly selected number or a continuously or monotonously increasing or decreasing number is generated in a remote service server and transferred both to the service device and to the postal data center in order to enable the postal shipment tracking.

Alternatively, identification that allows a postal shipment identification and contains data for identification of the service device is generated in the service device itself. The identification is also stored in a databank of the remote service server and are transferred to the postal data center in order to initiate a service of the postal data center for postal shipment tracking via at least this part of the postal shipment identification applied by the customer of a service server. Due to the postal shipment identification (SID) applied on the mail piece, the postal data center of the postal carrier can implement the service of a postal shipment tracking in a known manner and generate a PTI.

The service server remote from the service device queries the postal data center in time intervals with regard to an updating via the newest PTI. Typical examples for a PTI are a) tracking information and b) delivery notification.

While it is indirectly communicated via the tracking information (aforementioned example a)) that the mailing is not yet concluded, the aforementioned b) delivery confirmation indicates its successful conclusion. The queried PTI are transferred from the service server to the reception location via a communication connection. At the reception location, a suitable service device is programmed by an application program to collect, evaluate, prepare and display the PTI without specific request on the part of the authorized party. The PTI transfer ensues automatically given every communication of the service server with that service device that should signal the receipt of a PTI, or should automatically notify the authorized party. For this purpose, the communication with manufacturer data center can be used in connection with other services.

### DESCRIPTION OF THE DRAWINGS

FIG. 1 illustrates a franking imprint according to DPAG requirements

FIG. 2 shows basic system with a franking machine for franking of a letter envelope with a print image of a postal carrier with printed additional information.

FIG. 3 is a flowchart for the operation of the basic system according to FIG. 2.

FIG. 4 is a flowchart upon setting the alert flag.

FIG. 5 shows basic system with online feedback.

FIG. 6 shows a basic system with integration into an order management procedure.

FIG. 7 shows the control elements of a service device.

### DESCRIPTION OF THE PREFERRED EMBODIMENTS

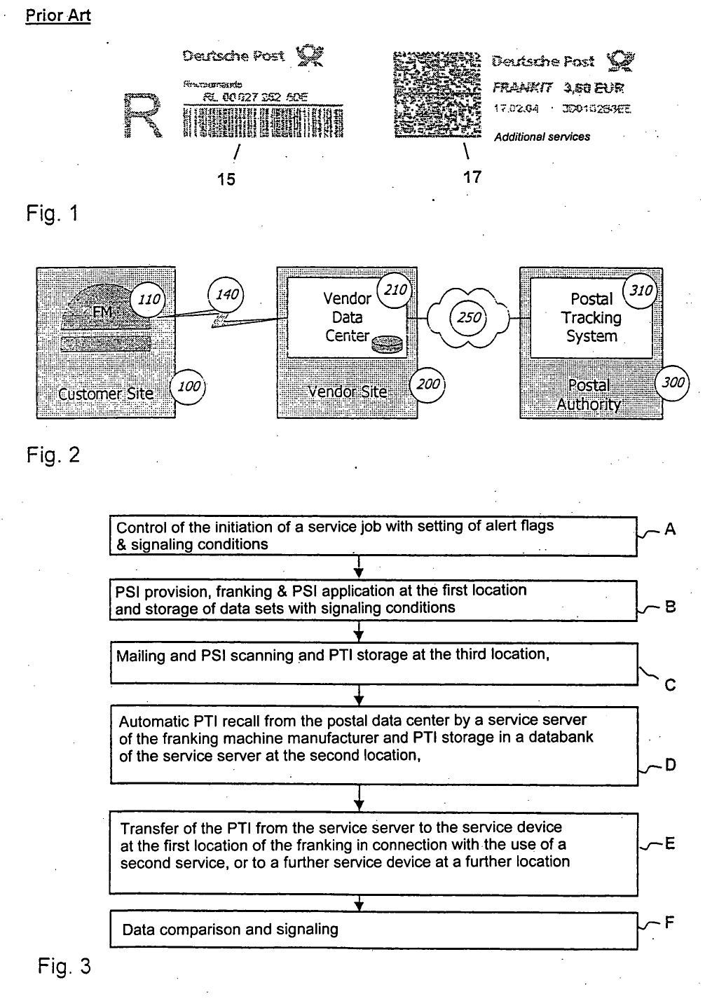

FIG. 1 shows a franking imprint according to the Frankit requirements of the Deutsche Post AG. At the left, the franking imprint has a one-dimensional bar code (1D barcode) 15 for an identcode, which is explained further below. Moreover, in the value imprint the franking imprint contains a two-dimensional barcode (2D barcode) 17 for the verification of the proper payment of the mail piece-carrying fee.

FIG. 2 shows a basic system with a franking machine for franking of a letter envelope with a print image of a postal carrier with printed additional information. The basic system is comprised of a franking machine 110 on the customer side or at the customer location 100 that is communicatively connected via a modem connection 140 with a data center 210 of the franking machine manufacturer at a remote second location 200. The data center 210 of the manufacturer in turn is connected via a data connection 250 with a postal tracking system 310 of a postal carrier that is located at a third location 300 that is remote from the both of the first-cited locations. The data connection 250 is preferably realized as an online connection, for example via Internet or frame relay.

The postal tracking system 310 provides PTI (postal shipment transport tracking information) about the mailing progress upon request for each shipment of all supported shipment types. Supported shipment types are typically certified mail, packages or packets. For this, at the pre-payment each shipment is impressed with an ID that we will call the shipment ID (SID) in the following. The preferable realization of the identification of shipments advantageously ensues via a barcode that can be reliably machine-read and evaluated, but alternative possibilities such as, for example:
a1) separate linear or 2D barcodes in which only the shipment specific identifier is contained.
a2) integration of the identifier into a linear or 2D barcode that is used anyway for the franking, i.e. provision of a separate data field in barcode otherwise used for other purposes.

The control of the franking machine or an equivalent device for generation of applicable postal shipment identification data ensues according to an application program.

The franking machines apply SIDs on the postal shipments as machine-readable barcodes, OCR or other, such that the postal tracking system can read these without error and, after transport of the shipments to their delivery, can create PTI and can supply said PTI to the manufacturer data center 210 via the connection 250.

In an alternative variant (not shown), the franking machine is replaced by another postal processing device, for example what is known as a PC franker. A PC equipped with a corresponding application program and modem is thereby connected with a conventional office printer.

In an alternative variant (not shown), the franking machine is communicatively connected with a first service device and with a second service device, whereby the latter is specific for the communication with a remote service server.

The franking machine 110 or the PC franker or the service device is equipped with an application program and includes an information processor to automatically (i.e. without separate instruction on the part of the authorized party) collect, evaluate, prepare and display the postal shipment transport tracking information (PTI). A component is, for example, a display readout that, in the rest state (when otherwise, for example, the time is displayed) displays the relevant portions of the current PTI. Moreover, a newly-received or not-yet read item of information can be indicated via a blinking identifier in the display or an additional color LED (light-emitting diode), or additionally via other existing signal means (beeper). Alternatively, an un-read notifications such as by e-mail, voice-mail, SMS ensues. The sequence of the information evaluation and provision is determined by the application program.

FIG. 3 shows a flowchart for the basic system. The flowchart is characterized by the steps A through F. In the first step A, via user interface the application program provides to the user of the machine at least one input possibility to set an alert flag for current postal shipments, as well as at least one selection possibility for a desired notification type about the achieved state in the execution of the mailing task by a postal carrier. The user of a franking machine 110 selects on the user interface specific shipments in which he sets an alert flag for these shipments. This can ensue in one of the following operation types:
a) In continuous operation, a franking machine 110 in principle always sets an alert flag for all shipment types for which the PTI can be provided by the postal tracking system.
b) In stack operation, the user prepares a stack of shipments that are all of one shipment type for which the postal tracking system can provide PTI. The user subsequently sets an alert flag for the entire stack, whereupon the franking machine 110 automatically sets an alert flag for each shipment of the stack.
c) In interactive operation, the user interface is queried about whether a service for shipment tracking is desired. This query appears only when the user has selected a shipment type for which the postal tracking system 310 can provide a PTI. It is checked whether the user has confirmed or rejected this query with a press of a button. If he confirms the query, an alert flag is set for the appertaining shipment.
d) In spontaneous operation, a key or a menu command is provided on the user interface (TRACE) that can be pressed at any time in the regular franking operation. The user can initiate the tracking for a package, in that he holds down the button TRACE in a defined time interval before initiation of the pre-payment. The appertaining shipment is thereupon provided with an alert flag. The time interval can be noted by an optical display before each pre-payment. The initiation of the TRACE key outside of a possible time window or for a shipment type for which no shipment tracking information can be queried can be automatically detected and ignored by the franking machine 110. The successful triggering of the TRACE button can be confirmed to the user via optical or acoustic signaling.

The franking machine 110 provides each shipment for which an alert flag has been set with a shipment ID (short SID). Shipment IDs are at least unique within a time window to be defined by the postal authority, thus are used for at most a single shipment during the time window in the appertaining postal market (across all franking machine manufacturers and all franking machines). The SID can be part of the franking notation or be separately printed and is preferably machine-readable. The SID can
1a) be generated by the franking machine 110 or
1b) be generated by the manufacturer data center 210 and have been received by the franking machine 110.

In both cases, the uniqueness can be guaranteed. In the first case this is accomplished by inclusion of a unique franking machine identification, in the second case by central comparison in the manufacturer data center 210. In both cases, in the manufacturer data center 210 it can be unambiguously established for each assigned SID by which franking machine 110 this has been printed. In the case 1a), in that it is checked which franking machine identification is contained in the SID. In the case 1b), in that the manufacturer data center 210 stores the information as to which SIDs have been assigned to which franking machine 110 in a databank of a service server.

In a franking machine 110, a condition (alert condition) optionally may have been stored in a storage for each shipment, to which condition the information processing means respond and which defines conditions for a warning or a signaling. This ensues, for example:
as soon as receipt confirmation arrives for this SID.
in the event that no receipt confirmation arrives within x days. The number x can thereby be pre-defined by the user.

If applicable, default values about the user interface are volunteered for each alert condition, such that the user can select from a number of offered signaling conditions.

A franking and generation of data sets ensues in the second step B. The franking machine 110 registers and stores the selected SID, the franking date, the franking time and the shipment type (certified mail, package, etc.), the alert flag and the signaling condition (alert condition) for each shipment to be tracked.

In the third step C, a known mailing and PSI scanning and PTI storage ensues via a postal data center located at a third location.

A fourth step D is provided for PTI query from the postal data center based on information of the service server and for transfer of the PTI to the service server in the manufacturer data center 210. Via the electronic interface 250 at the postal tracking system of the postal data center 300, the manufacturer data center 210 regularly queries the newest PTI regarding its storage in a direct voltage of the server at the second location. Typical examples for PTI are:
a) tracking information at the last transit location (as long as a shipment has not yet reached its receiver),
b) delivery confirmation,
c) receiver signature,
d) notification of refused acceptance,
e) notification of inability to deliver,
f) notification of a forwarding, since the address of the receiver had changed.

The query can ensue one or more times daily, however does not need to occur more frequently than the update cycle of the postal carrier for the postal tracking system 300. The manufacturer data center 210 can query the PTI at the postal tracking system as follows:
4a) for blocks of all SIDs in which the franking machine IDs occur that are supported by the appertaining manufacturer data center (210) (corresponds to case 1a of the step A) or
4b) individually query for each SID that has been assigned by the manufacturer data center (210) (corresponds to case 1b of the step A).

The transfer of the PTI from the service server to the service device of the user ensues in the fifth step E. The manufacturer data center 210 sorts and stores the PTI according to the franking machine ID and loads, each time a franking machine 110 communicates with the manufacturer data center 210, the corresponding PTI in the respective franking machine 110. A communication with a franking machine 110 can be initiated by
5a) the franking machine 110 upon request of a remote service such as, for example, PVD (postage value download), or
5b) by the franking machine 110 upon explicit request of the PTI (postal shipment transport tracking information),
5c) by the franking machine 110 implicitly each time when a new block of SIDs is requested from the manufacturer data center 210 (corresponds only to case 1b of step 1),
5d) by the manufacturer data center 210 promptly when respectively one current PTI is present. This option assumes that the franking machine 110 can be called via its own telephone number.

In each case, a modem connection exists between the manufacturer data center 210 and the franking machine 110, via which messages can be transferred in a manufacturer-specific or standardized protocol (for example SMS) in order to subsequently be displayed in the franking machine 110 or a connected peripheral device (for example a scale).

A data comparison and a signaling by a service device of the user is provided in the sixth step F. In the franking machine 110, the shipper data (SIDs, franking date, franking time, shipment type) stored in the second step B are connected with the PTI that have been loaded in the fifth step E. The prepared data can be made aware to the user in various manners.
6a) open items list: The data are prepared such that those SIDS for which no receipt confirmation exists and how many days/hours have respectively elapsed since franking are continuously visible on the display upon request.
6b) shipment history: A more general status is displayed regarding the last n SIDs:
   yellow: shipment has not yet arrived at the receiver,
   green: delivery confirmation exists,
   red: delivery confirmation is overdue (does not exist after expected transport duration), or delivery was not possible, or acceptance was declined.
6c) detail information: The user can query the existing detailed shipment tracking information regarding individual SIDs.
6d) filter: The user can filter out groups of SIDs and query the shipment tracking information for these. Examples of filters: all shipments that have been franked within the last 7 days; all certified mail that has been franked within the last 30 days, etc. Moreover, all alert conditions are automatically checked whose alert flags are still set and are displayed according to the respective alert condition.

In an alternative version, a franking machine is connected with an additional administration PC. In particular for customer inputs in step A) or subsequent corrections, as well as the administration of the customer settings necessary from time to time (for example manual resetting of alert flags), a personal computer with communication interface to the franking machine can optionally be used when this offers a simplified handling and more oversight via more comfortable and efficient input and display possibilities.

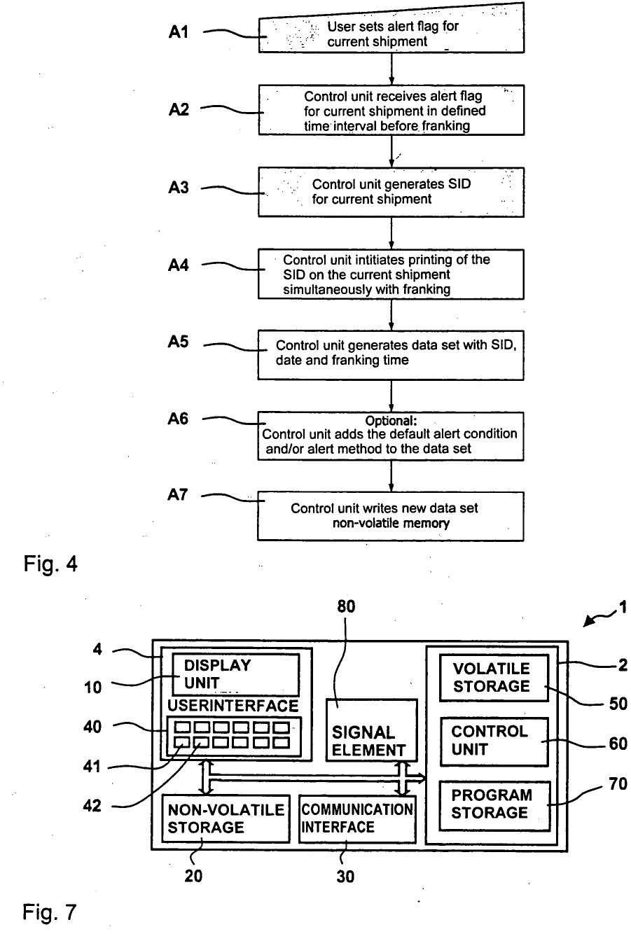

FIG. 4 shows a flowchart upon setting the alert flag. The flowchart is characterized by the steps A1 through A7. In the first step A1, via user interface to the user of the machine the application program provides an input possibility to set an alert flag for current postal shipments.

The arrangement for control and use of a service provided by the postal system for tracking and monitoring of postal shipments is preferably realized in a franking machine. The evaluation of the inputs ensues via information processing means such as, for example, via a control unit of the franking machine. In the step A2, the control unit of the franking machine registers an alert flag input for the current shipment, advantageously in a defined time interval before the franking. According to a step A3, the control unit of the franking machine then generates an SID for the current shipment and, according to a step A4, initiates the imprint of the SID on the surface of the current shipment together or, respectively, in the same working step with the franking. In the step A5, the control unit of the franking machine generates a data set with the SID, with date and franking time. In the optional step A6, the control unit of the franking machine adds the default/alert condition and/or the alert method to the data set according to an input or automatically. In the step A7, the control unit of the franking machine writes a new data set in a non-volatile storage.

In the embodiment variant specified above, the existing hardware and software of a franking machine and the possibilities of the data center at the franking machine manufacturer, as well as the possibilities of the postal data center, are advantageously used. The costly and time-consuming PTI query at the postal data center is automated and left to a server of the data center at the franking machine manufacturer, which sorts the PTI according to franking machine serial numbers and waits to download the data into the franking machine given an occasional communication with the users, i.e. without the user thereby being incommoded. The routine contained in the application program runs completely in the background.

In the subsequently described embodiment variants, a greater attentiveness of the user for postal shipments to be monitored or critical postal shipments is achieved by the use of additional measures.

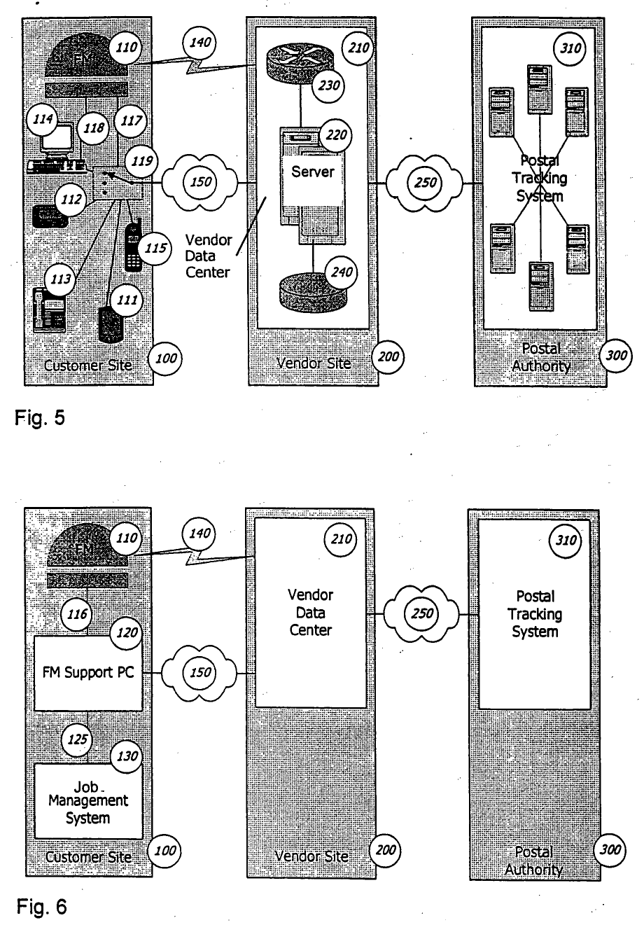

A basic system with online feedback is explained with reference to FIG. 5. A greater attentiveness of the user is achieved by the machine for the application of the postal shipment identification being a franking machine and by the service device being a separate communication terminal device. An online interface 150 to the manufacturer data center 210 additionally exists, such that the user can be notified of his selection by the manufacturer data center 210 with the aid of an end device. The interface 150 can be realized via one or more of the following communication networks: Internet, frame relay, fixed network (analog, ISDN, DSL), mobile radio network.

Following is a list of communication end devices via which the user at the interface (150) can be notified:
organizer 111,
pager 112,
telephone with answering machine/speaker box 113,
PC with e-mail functionality 114,
mobile telephone 115,
franking machine 110.

One or more of these or other terminal devices can be connected directly to the physical interface 150 or via a gateway (not shown), insofar as the appertaining end device does not support the communication protocol of the interface 150. The representation of a switch 119 is abstracted from these differences in the system architecture and is naturally in practice thus not present at the shown location. Rather, the switch 119 describes a technical possibility of the user interface to make a selection, such that the manufacturer data center 210 can optionally address an end device selected by the FM user.

The manufacturer data center (vendor data center) 210 is equipped with at least one server 220 that, on the one hand, is connected with the customers via a WAN connection 150 (for example Internet, frame relay, etc.) and, on the other hand, is connected with the distributed server system (postal tracking system) 310 of a postal authority 300 via a WAN connection 250. The manufacturer data center (vendor data center) 210 is, for example, equipped with a server cluster and furthermore comprises a modem server 230 or a similar communication device in order to be reachable for a modem of the franking machines via the telephone network 140, as well as a databank management system (DBMS) 240 in order to collect and prepare PTI transferred from the postal tracking system and, upon request, to forward them to the appertaining customers.

In contrast to the basic method explained using FIG. 3, some steps in the basic method with online feedback according to FIG. 5 are changed as follows:
Step A: The first step A of the basic method is expanded into two sub-steps:
Aa) Input of information about a selected signaling method (alert method) for specification of on which path or, respectively, in which manner the desired PTI should be transmitted to the user.
Ab) Transfer of information about the input of alert flag, the alert conditions as well as the selected alert method from the service device 110 to the manufacturer data center 210.

In connection with the sub-steps A1), A6) or separately, Aa), in an advantageous manner the selection possibility now exists that the customer also specifies an alert method in addition to the alert flag and the alert condition, which alert method specifies the notification with regard to the desired communication end device. Examples for alert methods are: e-mail, voice mail on answering machine/speaker box of the customer as well as short text messages of a short message service (SMS).

The step Ab) for transfer of information via the input by the service device 110 to the manufacturer data center 210 is repeated in regular intervals. For example, alert flag, alert conditions as well as the desired alert method are communicated at the end of each day from the service device to the manufacturer data center 210 via the communication interface 150. The service device is, for example, the franking machine 110. Alternatively, the service device is, for example, a personal computer (PC).

Step B: In addition to storage of the shipment-related data, the service device 110 transfers these shipment-related data to the manufacturer data center 210, where they are stored in a databank of the databank management system (DBMS) 240.

Step C: remains unchanged relative to the basic method according to FIG. 3.

Step D: The function of the service server 220 in the fourth step D is expanded by a shipment-related evaluation of each service device. The shipment-related evaluation of, for example, each sender or, respectively, franking machine only ensues in the sixth step F at the location 100 of the franking in the service device or in the franking machine 110 in the basic method according to FIG. 3. In contrast to this, this now already occurs in the fourth step D, also in the manufacturer data center 210.

Step E: To supplement the step E of the basic method, the current PTI are sent from the manufacturer data center 210 to the communication end device of the user, whereby the end device and the corresponding transfer protocol are selected according to the alert method specified for a shipment. The selection of the end device ensues in the step Aa) via user interface, which is clarified in abstract in FIG. 5 by a logical switch 119, and whose effect on the notification or, respectively, signaling method (alert method) is explained in the following. In the fifth step E, the function of the service server 220 is expanded by a prompt production of a communication connection from the manufacturer data center to the communication end device of the user, which automatically ensues as soon as new PTI for franked and shipped postal shipments are available. The following options are provided for this:

Organizer

The manufacturer data center 210 addresses an organizer 111 specified by the user in the second step B. The organizer can be addressed via a local radio network 150 (for example Bluetooth, Airport, etc.) at the user, whereby an online notification of the user can be achieved. The organizer can also load its current messages via a PC 114, thereby synchronize with the manufacturer data center 210 at regular time intervals or at the need of the user.

Pager

Using the telephone number imparted by the user, the manufacturer data center 210 addresses a pager 112 specified by the user in the second step B. The manufacturer data center prepares the PTI in the pager format. As soon as the pager 112 receives the message, it optionally outputs an acoustic signal or a vibration signal in order to make the user aware of the arrival of a new message. In this case, the interface 150 is realized by a telephone fixed network.

Telephone with Answering Machine/Speaker Box

Using the telephone number imparted by the user, the manufacturer data center 210 addresses a telephone 113 or a mobile telephone 115 specified by the user in the second step B. The selection of the communication end device via user interface is again symbolized by a logical switch 119. The PTI is prepared in an acoustic signal by the manufacturer data center 210 with the aid of a voice synthesizer, which acoustic signal can be recorded on an answering machine or a voice box of the user. In this case, the interface 150 is realized via a telephone fixed network or mobile radio network.

PC with E-Mail Functionality

Using the e-mail address imparted by the user, the manufacturer data center 210 addresses an e-mail account specified by the user in the second step B. The PTI is prepared by the manufacturer data center 210 in an e-mail text or a corresponding attachment that the user can request, read and/or print out via a separate printer (not shown) with the aid of a PC 114.

In this case, the interface 150 is realized via the Internet. The selection symbolized by the switch 119 concerns an option for an e-mail client protocol, for example POP, S/MIME, MS-OUTLOOK, etc.

PC with File Transfer Function

The manufacturer data center 210 provides for each franking machine an directory that can be accessed with the aid of a file transfer protocol via the Internet. The directories can thereby be respectively named after the franking machines whose PTI they should later contain. Each franking machine is identifiable by a serial number. The PTI is prepared by the manufacturer data center 210 in a text/graphic file and is stored in the corresponding directory and provided for download. At regular time intervals or as needed, the user downloads the available files from the manufacturer data center onto his PC 114, with the help of which the files can be read and/or printed out.

Franking Machine

The franking machine offers a serial or parallel interface 118 to a PC 114, thus a PC 114 with e-mail or file transfer functionality is used. After receipt of current PTI in the PC 114, this transfers the PTI via a communication interface 118 to the appertaining franking machine 110 in order to display it there.

Alternatively, the function of the communication transmission device 111, 112, 113, 114, 115 can be integrated into the service device 110 which itself already offers network connection and Internet capability. A franking machine itself thus already offers network connection and Internet capability, by already being equipped with e-mail or file transfer functionality via the Internet. Thus the PC 114 can—as shown above—can be omitted. This option can be selected, which is symbolized in FIG. 5 by the switch 119 and is described by the direct connection 117 between the franking machine and the interface 150, with the latter being realized via the Internet. The franking machine can additionally indicate newly arrived messages via an acoustic notification.

Step F: remains unchanged relative to the basic method.

A basic system with integration in a job management is explained using FIG. 6. The basic system can be integrated into a job management of the user. This is desirable when the user generates shipments for individual jobs of his customers, the delivery of which shipments is a significant step of the job and should correspondingly be tracked and monitored. Typical application examples of such users are banks that, upon request, send credit cards, EC cards, cash cards, etc. to their customers or associations, foundations, authorities, firms, cooperatives, etc. that, upon request, send membership cards to their customers.

In these cases, the user typically has a job management system in which the user also would like to track the shipments that belong to a job. In this case, the basic method can be integrated into the job management system (for example SAP) at the user, with an online communication interface to the manufacturer data center 210 being used analogously to the manner already described.

The franking machine 110 is connected via a communication interface 116 with a franking machine support personal computer 120, which in turn has an online communication interface 150 to the manufacturer data center 210. In terms of its function, the franking machine support PC 120 has nothing to do with the administration PC that was described above in the preceding exemplary embodiment (FIG. 2) as an optional configuration aid; rather, it has a communication interface 125 to the job management system 130 of the user. If both functions are desired, the franking machine support and administration functions are implemented on the same physical personal computer.

Step A: In this step, the initiative to set alert flags for specific shipments originates from the job management system 130. In large postal processing systems, the combination of shipments, for example letters with forms and credit cards, are centrally controlled by a computer in letter envelopes and their supply into the franking machine 110, such that an integration into a job management of the customer is obvious. If such a postal processing system is not available, a franking machine as follows can be integrated into a job management system. In step A, the franking machine 110 operates in stack operation, such that an alert flag is set for each shipment of a stack prepared by the user. To link a job number with the associated shipment ID that is used by the franking machine 110, in step B we consider two configuration variants of the franking machine: with or without built-in scanner that can read suitable coded information from a letter envelope.

Step B: In addition to the storage of the shipment-related data, the franking machine 110 transfers these shipment-related data to the FM support PC, which forwards them to the job management system. There they are linked with the corresponding job data.

Franking Machine Without Scanner (Conventional Configuration)

In this configuration, the user prepares a stack of shipments whose shipping he would like to track. He selects the shipment type and the notification of the FM support PC as an alert method for all shipments of the stack, for example via e-mail. The user now sorts the shipments corresponding to the lists of the associated jobs in the job management system 130. After pre-payment of all shipments of the stack, the sorted list of the generated data sets (made up of, respectively, SID, franking data, franking time, shipment type (certified mail, packages, etc.), alert flag and alert method) that have been generated by the franking machine 110 for the shipments of the processed stack is transferred from the franking machine 110 to the FM support PC 120 via the interface 116. The FM support PC forwards the list of the received data sets to the job management system, where they are associated with the corresponding jobs according to their sequence.

Franking Machine with Scanner (Expanded Configuration)

In this configuration, the user likewise provides a stack of shipments whose shipping he would like to track. In the production of the shipments, the job number of the respective shipment is noted in machine-readable form (for example as a barcode) on each envelope or in the address window of each envelope. Sorting of the shipments into a stack is not necessary.

The user selects the shipment type and the notification of the FM support PC as an alert method for all shipments of the stack, for example via e-mail. The user now sends the stack through the pre-payment in the franking machine. During the stack processing, the job number is read from each supplied envelope by means of a scanner, an SID is selected, imprinted, and subsequently the data set (made up of job number, SID, franking data, franking time, shipment type (certified mail, packages, etc.), alert flag and alert method) is stored in the franking machine 110. The data sets are transferred via the interface 116 to the FM support PC 120 and from there are forwarded to the job management system 130 via the interface 125. The transfer can ensue immediately for each data set or in collected form, whereby a number of data sets are collected in the franking machine 110 and/or in the FM support PC and are subsequently transferred packet-by-packet to the job management system.

Step C: remains unchanged relative to the basic method.

Step D: remains unchanged.

Step E: In a modification of the basic method, here the franking machine 110 does not receive the PTI, but rather the FM support PC does as it is predetermined by the alert method. Technically, this can occur via push services such as e-mail or www services that have been initiated by the manufacturer data center 210 or via pull services, whereby the manufacturer data center 210 provides the current information and the FM support PC requests and retrieves (ftp) this information in regular intervals.

Step F: The FM support PC forwards the received PTI to the job management system where they are linked with the corresponding jobs. For example, the SID can be used as a key in the databank of the jobs. Depending on the PTI for each job, the corresponding progress in the shipping is noted and, if applicable, further suitable measures are initiated.

An arrangement to implement the method possesses at least information processing means and a user interface and, in a preferred variant, is a component of a service device which is programmed to control a notification of the user as a result of the receipt or non-receipt of a PTI, corresponding to a selected pre-set about the notification type, after the receipt of a PTI returned by the service server during the implementation of the postal shipping. The service device is programmed, for example, programmed such that a non-receipt of a PTI within a stipulated time window is established and a notification of the user ensues with regard to the delayed mail piece transport.

In a further embodiment, the service device 110 is a franking machine and the information processor includes a control unit of the franking machine. The franking machine includes a first selector that serves for selection of the printing of a section of the print image that contains the postal shipment identification. The first selection means is connected with the control unit, whereby the latter controls the printer means such that the selected section is printed on a fixed, assigned, predetermined position. It is thereby ensured that the selected section 17 designating a postal carrier is printed on a first position, and the respectively selected section 15 designating a postal shipment identification is printed on a second position.

In an alternative embodiment variant, it is provided that the machine for application of the postal shipment identification is a franking machine, and that the service device is a separate communication end device.

In a further alternative embodiment variant, it is provided that the service device is a personal computer and that the information processing means include a control unit of the personal computer. The personal computer 120 is communicatively connected with a franking machine 110 via a first interface 116 and is communicatively connected with a job management system 130 via a second interface 125, whereby the personal computer 120 exhibits a franking machine support function. Another variant is for the franking machine support and administration functions to be implemented on the same physical personal computer.

In FIG. 7, control element of a service device is shown, having a whose volatile working memory 50, control unit 60 and a program memory 70 form the aforementioned information processor 2 and whose display 10 and input or operating unit 40 form the aforementioned user interface 4. A communication interface 30 and a non-volatile memory 20 are operatively connected with the information processor 2 and the user interface 4. As has already been mentioned, for example, a franking machine whose user interface is comprised of the components display 10 and the input 40 is equipped with such an arrangement of control elements. At least one operating element 41 controls the initiation of the service job and the input of alert flags, alert conditions and alert methods. Alert flags can be promptly input at the current printing of a mail piece via the press of a single button, or an optical or acoustic signal can be input. For input of an alert flag, a rapidly operating element is provided, such that a user can also set an alert flag for individual postal shipments given stack processing. In the following, some exemplary embodiments are described:
separate physical button integrated into the keypad of the franking machine,
separate virtual button integrated into a touchscreen,
speed dialing button,
separate touchpad or physical button in spatial proximity to the letter transport path,
mobile microphone that can be carried on the body of the user with downstream acoustic evaluation, such that the user can set an alert flag via a stipulated, clearly spoken command such as, for example, “alert”.
initiation of an electrical or optical contact (light barrier) via contact of the desired shipment or indication of this while the mail piece is still located in the letter transport, prior to the printing.

The list of the SIDs is held with the associated data in the non-volatile memory 20. Each data set of the list contains SID, alert condition, alert method, result. For each shipment for which an alert flag is set, a new data set is incorporated into the list. The SID is unambiguously assigned for each data set, for example by increasing numbering in a sufficiently large number interval. The alert condition and alert method are stored with storage efficiency via reference to an alert condition or alert method within a small group of possible alert conditions or, respectively, alert methods. As soon as a delivery result (SID result) arrives, this is linked with the corresponding data set in the list (linking occurs via SID) and the result is stored in the appertaining data set (field: result). The storage administration of the list can be set such that a data set is deleted from the list after a pre-set time, or as soon as a user explicitly invokes its deletion on the user interface. For processing of postal shipment transport tracking information (PTI), two operating elements 42 are provided. By means of this and other (not shown) operating elements, a selection switch 119 for franking machine 110 can also be realized that is symbolically represented in FIG. 5. The volatile storage serves for temporary data processing during the letter processing or PTI evaluation. The information processor 2 are connected with a signal element 80, for example a beeper. Moreover, the franking machine has a communication interface 30 with which it can establish a connection to the manufacturer data center 210 or a connection with a FM support PC 120. The cited component display, input or operating unit, storage and communication interface are coordinated by the control unit 60.

In addition to the embodiments explained with regard to FIGS. 2, 5 and 6, further arrangements or, respectively, embodiments of the invention for signaling the feedback to the end customer are conceivable:

In one such embodiment with call forwarding, the franking machine is informed by the data center as soon as the franking machine has established a modem connection to the data center. The franking machine is) connected to one or more PCs via a serial cable or a local network and signals the feedback information via the PC or PCs. Via its modem interface, the franking machine forwards the call to another end device online or with a time delay according to the selection of the customer, who possesses a telephone connection. Viewed technically, this variant is closer to the embodiment variants to FIG. 2, because here as well the connection between data center and the franking machine FM is initiated by the user.

In on such another embodiment, switching software is located in the data center; stored in the data center by one or more end devices (end devices that possess telephone connection or Internet connection) are the addresses (typically telephone numbers or e-mail addresses) via which the customer desires to receive the feedback information.

In another embodiment, a switching software is located in the personal computer. Stored in the data center are the (i) e-mail address or (ii) modem telephone number of the personal computer PC specified by the customer. The PTI or feedback information is transferred by the data center to this e-mail address (i) or telephone number (ii). The PC either displays the PTI or feedback information itself and/or it forwards it to an end device selected in advance by the customer. For example, the franking machine or organizer can be connected with a telephone connected via a serial cable or local network, other end devices, which can be addressed by the modem of the PC.

Although modifications and changes may be suggested by those skilled in the art, it is the intention of the inventor to embody within the patent warranted hereon all changes and modifications as reasonably and properly come within the scope of his contribution to the art.

1. A method for controlling use of a service provided by a postal system for tracking and monitoring postal shipments, comprising the steps of:
A) upon entry of a user input into a service device located at a first location, controlling initiation at said service device of a service task for tracking transported postal shipments and processing postal shipment transport tracking information (PTI) in the service device, including pre-setting of signaling conditions;
B) in said service device at said first location, generating and storing a dataset, including said signaling conditions, upon franking of a mail piece at said service device, including applying a postal shipment identification (SID) to said mail piece;
C) causing said mail piece to enter into a delivery stream of a carrier and generating said PTI in said delivery stream and providing said PTI to a third location remote from said first location;
D) automatically recalling said PTI from said third location and transferring said PTI from said third location to a second location, and storing said PTI at said second location;
E) processing said PTI at said second location and communicating said PTI from said second location to a user of said service device; and
F) notifying said user according to the preset signaling condition of communication of said PTI to said user.

2. A method as claimed in claim 1 wherein:
step A) comprises setting of alert flags and signaling conditions and providing postal shipment identified;
step B) comprises applying said SID to said mail piece in machine-readable form;
step C) comprises scanning said SID on said mail piece at a point in said delivery stream of said carrier and transferring the scanned SID to a postal data center of said carrier at said third location;
step D) comprises transferring said PTI from said postal data center to a service center, at said second location, of a manufacturer of said service device and storing the PTI in a data base at said service center;
step E) comprises including a request for transferring said PTI from said second location to said service device in a request for a further service, independent of said PTI, from said service device to said service server, identifying said service device by service device identification data and transferring said PTI from said service server to said service device dependent on said service device identification data upon providing said second service to said service device; and
step F) includes at said service device, comparing said PTI to said franking.

3. A method as claimed in claim 2 wherein step A) comprises:
allowing entry of an alert-flag for a current postal shipment, including said mail piece, via a user interface of said service device;
upon entry of said alert-flag into said service device, registering entry of said alert-flag in a control unit of said service device;
generating said SID for said current postal shipment in said control unit;
from said control unit, initiating and controlling printing of said SID on said mail piece together with said franking; and
generating said dataset in said control unit containing said SID, a date of said current postal shipment, and a time of said franking.

4. A method as claimed in claim 3 wherein step A) further comprises:
automatically including at least one of a default/alert condition and an alert procedure in said dataset by said control unit as long as said alert flag is entered into said control unit within a defined time interval preceding said franking; and
writing, via said control unit, said dataset into a non-volatile memory in said service device.

5. A method as claimed in claim 2 wherein step D) comprises:
communicating said SID from said service device to said service server;
communicating at least a part of said SID from said service server to said postal data center to initiate transfer of said PTI from said postal data center to said service server; and
storing said PTI in said data base at said service server associated with identification data that identify said service device.

6. A method as claimed in claim 5 where said SID identified a said service device.

7. A method as claimed in claim 6 comprising automatically generating in said service device an identifier serving as said identification data.

8. A method as claimed in claim 5 comprising including said identification data in said part of said postal data communicated from said service server to said postal data center.

9. A method as claimed in claim 2 wherein step A) comprises, upon entry of said user input, establishing a communication between said service device and said service server and, at said service server, generating an identifier, containing no address information, no shipping information and no information concerning said franking, and communicating said identifier from said service server to said service device for inclusion in said SID, and communicating said identifier to said postal data center to initiate transfer of said PTI from said postal data center to said service server.

10. A method as claimed in claim 9 comprising generating said identifier as a number selected from the group consisting of random numbers, monotonously increasing numbers, and monotonously decreasing numbers.

11. A method as claimed in claim 2 comprising automatically communicating respective queries, at respective time intervals, from said service server to said postal data center for updating said service server with most recent PTI.

12. A method as claimed in claim 2 comprising, upon communication of said PTI from said service server to said service device, automatically collecting, evaluating and displaying said PTI at said service device without a request from said user, and notifying said user of receipt of said PTI at said service device in a predetermined manner.

13. A method as claimed in claim 2 wherein step A) comprises:
including in said signaling conditions a signaling method specifying at least one of a path and a manner by which said PTI is to be transmitted to said user; and
communicating information including input of said alert flag and said signaling conditions from said service device to said service server.

14. A method as claimed in claim 13 comprising communicating said information including input of said alert flag and said signaling conditions from said service device to said service server at regular time intervals.

15. A method as claimed in claim 14 comprising communicating said information including input of said alert flag and said signaling conditions from said service device to said service server at an end of each day.

16. A method as claimed in claim 2 wherein step B) comprises storing data relating to said postal shipment in said service device and thereafter communicating said data associated with said postal shipment from said service device to said service server.

17. A method as claimed in claim 2 wherein step D) comprises said service center conducting an evaluation of said PTI giving priority to those PTI that belong to certain service devices.

18. A method as claimed in claim 2 comprising communicating said PTI from said service server to said service device in step E) as soon as said PTI are communicated from said postal data center to said service server in step D).

19. A method as claimed in claim 2 wherein step E) comprises communicating said PTI from said second location to a communication terminal device and transferring said PTI from said communication terminal device, via a communication interface, to said service device, and displaying said PTI at said service device.

20. A method as claimed in claim 2 wherein E) comprises communicating said PTI from said service server to a communication terminal device integrated into said service device, said communication terminal device offering a network connection and Internet capability.

21. An arrangement for controlling use of a service provided by a postal system for tracking and monitoring postal shipments, comprising:
an information processor having a user interface and a display unit and an operating unit;
said operating unit comprising operating elements allowing initiation of a service task to track a transported postal shipment, and second operating elements allowing processing of postal shipment transport tracking information (PTI);
said information processor also having a volatile memory and a control unit with a program memory for a tracking program, said control unit being operationally connected with said user interface;
a communication interface; and
a non-volatile memory for said PTI and also containing signaling conditions relating to said shipment tracking.

22. An arrangement as claimed in claim 21 forming a component of a service device which, after receipt of a PTI sent by a remote service server via the communication interface during implementation of the postal shipping, is programmed to control information processing and notification to a user as a result of receipt or non-receipt of the PTI, dependent on a presetting containing said signaling conditions.

23. An arrangement as claimed in claim 22 wherein the service device comprises a signal element connected with the information processor via which the service device is programmed for notification of the user regarding a delayed transport of said postal shipment when non-receipt of a PTI occurs within a predetermined time window after franking of the postal shipment.

24. An arrangement as claimed in claim 22 wherein the service device is a franking machine having a franking machine control unit including the information processor, and further comprising a printer connected to the franking machine and controlled by the franking machine control unit.

25. An arrangement as claimed in claim 24 comprising a selector for selecting printing of a section of a print image on the postal shipment that contains a postal shipment identification, said selector being connected with the franking machine control unit for causing a selected section to be printed on a predetermined position in a franking imprint on said postal shipment.

26. An arrangement as claimed in claim 25 wherein said selector designates a first selected section characterizing a postal carrier that is printed at a first position in said franking imprint, and a second selected section characterizing the postal shipment identification that is printed at a second position in the franking imprint.

27. An arrangement as claimed in claim 21 comprising a franking machine that applies a franking imprint containing information about said postal shipment on said postal shipment, and comprising a service device, containing said communication interface, said service device being a communication terminal device.

28. An arrangement as claimed in claim 21 forming a component of a personal computer having a personal computer control unit, with said information processor being a component of said personal computer control unit.

29. An arrangement as claimed in claim 28 comprising a franking machine in communication with said personal computer via a first interface, and a order management system in communication with said personal computer via a second interface, said personal computer being programmed for supporting operation of said franking machine.

30. An arrangement as claimed in claim 29 wherein said personal computer also is programmed to perform administration functions associated with said franking machine.

31. An arrangement as claimed in claim 28 comprising a franking machine in communication with said personal computer, said franking machine transferring said PTI, upon receipt thereof via said communication interface, to said personal computer, and said personal computer containing said display unit, at which said PTI is displayed.
